(19) United States
(12) Patent Application Publication
(10) Pub. No.: US 2010/0254496 A1
(43) Pub. Date: Oct. 7, 2010

(54) NOISE POWER ESTIMATION METHOD AND DEVICE THEREOF

(76) Inventor: Guo-Hau Gau, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/419,267

(22) Filed: Apr. 6, 2009

(51) Int. Cl. H04B 1/10; H04L 27/28

(52) U.S. Cl. 375/346; 375/260

(57) ABSTRACT

A noise power estimation method for estimation of channel state information in OFDM systems is provided. The noise power estimation method includes: calculating an evaluated noise power for a specific subcarrier of a current symbol; comparing a target threshold with the evaluated noise power to generate a comparison result; and determining a final noise power for estimating channel state information by adjusting the evaluated noise power according to the comparison result.

### BACKGROUND OF THE INVENTION

1. Field of the Invention

The present invention relates to noise power estimation, and more particularly, to a noise power estimation method and a noise power estimation circuit for estimation of channel state information (CSI) in OFDM systems.

2. Description of the Prior Art

Noise power estimation is important in receiver systems. In OFDM communication systems, however, a conventional noise power estimation scheme (such as a channel state information (CSI) device) of the receiver usually fails to derive the noise power precisely, and more problematically, the conventional noise power estimation system underestimates the noise power when the processing subcarrier is a nullified subcarrier. The derived inaccurate noise power will seriously degrade the performance of the OFDM receiver.

In a conventional OFDM receiver, a channel state information (CSI) circuit estimates the power of the existing noise N of the received signal to generates the corresponding channel state information (CSI). For instance, the noise existing in the K^{th} subcarrier on the S^{th} symbol can be denoted as \hat{N}_{s,k}, and the variance (denoted as Var \hat{N}_{s,k}) of the noise existing in the K^{th} subcarrier on the S^{th} symbol can be used to express the noise power. As mentioned above, the accuracy of the noise power estimation excessively affects the performance of the OFDM receiver. In an actual case, the noise \hat{N}_{s,k} can be estimated as below:

$${\hat{N}}_{s , k} = {Y}_{s , k} - {\hat{H}}_{s , k} \cdot DEC ( \frac{{Y}_{s , k}}{{\hat{H}}_{s , k}} ) \qquad ( 1 )$$

where Y_{s,k} is the Fast Fourier Transform (FFT) output of the K^{th} subcarrier on the S^{th} symbol; Ĥ_{s,k} represents the estimated channel response corresponding to the K^{th} subcarrier on the S^{th} symbol; and DEC{.} expresses a hard decision function. After obtaining the estimated noise \hat{N}_{s,k} from equation (1), the corresponding noise power can be easily derived.

One of the most popular mathematic ways to get the noise power (Var \hat{N}_{s,k}) is to apply an infinite impulse response (IIR) averaging method, and the noise power derived by the IIR averaging method is expressed as follows:

Var N_{s,k}=α·|\hat{N}_{s,k}|²+(1−α)·VarN_{s-1,k}0<α≦1 (2)

After deriving the noise power, corresponding channel state information (CSI) is evaluated based on the square of the estimated channel response (Ĥ_{s,k}) and the noise power, as follows:

$${CSI}_{s , k} = \frac{{\vert {\hat{H}}_{s , k} \vert}^{2}}{Var {N}_{s , k}} \qquad ( 3 )$$

Unfortunately, the existing OFDM system in the conventional OFDM receiver still fails to get a precise CSI especially when the CSI corresponds to the nullified subcarrier.

Therefore, there is a demand for a precise noise power estimation circuit and method thereof that overcomes the aforementioned disadvantages and thereby improves the performance of OFDM receivers.

### SUMMARY OF THE INVENTION

It is therefore one of the objectives of the present invention to solve the aforementioned problems by providing a novel noise power method and a noise power estimation circuit thereof for improving the performance of the OFDM system employing the noise power method/noise power estimation circuit of the present invention.

According to one exemplary embodiment of the present invention, a noise power estimation method for estimation of channel state information in OFDM systems is provided. The noise power estimation method includes following steps: calculating an evaluated noise power for a specific subcarrier of a current symbol; comparing a target threshold with the evaluated noise power to generate a comparison result; and determining a final noise power for estimation of channel state information by adjusting the evaluated noise power according to the comparison result.

According to another exemplary embodiment of the present invention, a noise power estimation circuit for estimation of channel state information in an OFDM receiver is provided. The noise power estimation circuit includes: a calculating circuit and an adjusting circuit. The calculating circuit calculates an evaluated noise power for a specific subcarrier of a current symbol. The adjusting circuit compares a target threshold with the evaluated noise power for the specific subcarrier of the current symbol to generate a comparison result, and obtains a final noise power for estimation of channel state information adjusts the evaluated noise power according to the comparison result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an OFDM receiver according to an exemplary embodiment of the present invention.

FIG. 2 is a block diagram illustrating an exemplary embodiment of a channel state information estimation circuit shown in FIG. 1.

FIG. 3 is a flowchart illustrating a simplified noise power estimation method according to an exemplary embodiment of the present invention.

FIG. 4 is a diagram illustrating an exemplary relation between the reference noise power, the predetermined constant and the evaluated noise power according to a second exemplary embodiment of the present invention.

### DETAILED DESCRIPTION

Certain terms are used throughout the following descriptions and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “coupled” and “couples” are intended to mean either an indirect or a direct electrical connection. Thus, if a first device couples to a second device, that connection may be through a direct electrical connection, or through an indirect electrical connection via other devices and connections.

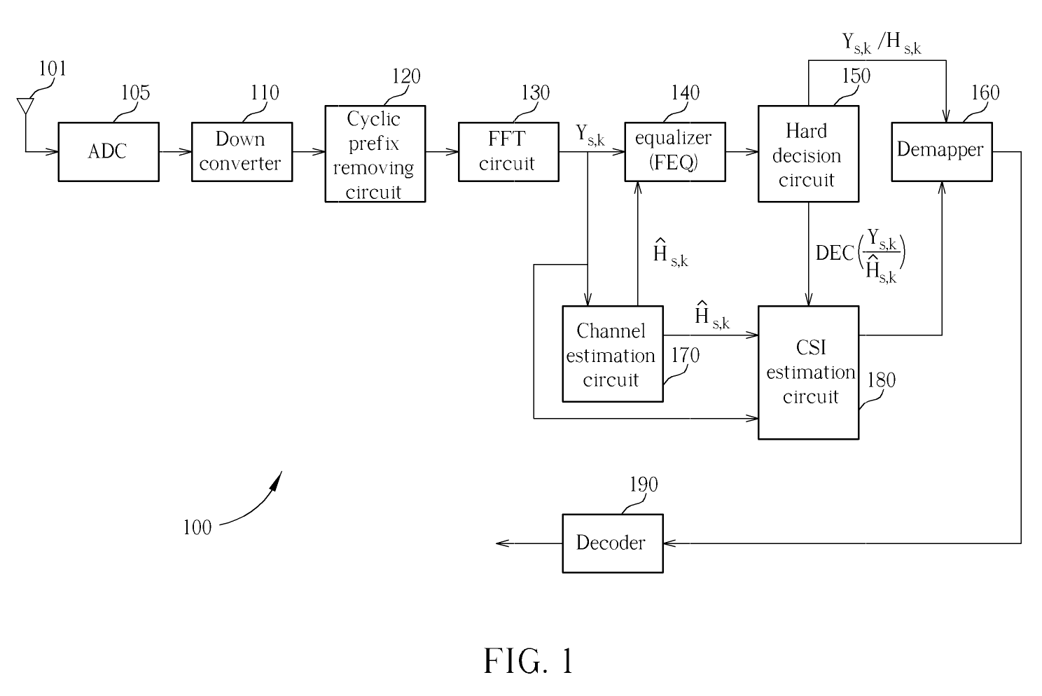

Please refer to FIG. 1. FIG. 1 is a block diagram illustrating an OFDM receiver 100 according to an exemplary embodiment of the present invention. In FIG. 1, the OFDM receiver 100 includes (but is not limited to) an antenna 101, an analog-to-digital converter (ADC) 105, a down converter (e.g., a digital down converter) 110, a cyclic prefix removing circuit 120, a fast Fourier transform (FFT) circuit 130, an equalizer (e.g., a frequency-domain equalizer) 140, a hard decision circuit 150, a demapper 160, a channel estimation circuit 170, a channel state information (CSI) estimation circuit 180, and a decoder 190. It should be noted that the aforementioned structure in FIG. 1 is for illustrative purpose only. In other words, the OFDM receiver 100 may include more circuit elements according to the different design requirements.

The received signal from the antenna 101 is converted from an analog form into a digital form by the ADC 105, and then the digital received signal from the ADC 105 is down-converted into a baseband signal. The baseband signal is processed by the cyclic prefix removing circuit 120 for removing the cyclic prefix included therein. After executing an FFT operation by the FFT circuit 130, wherein the FFT circuit 130 is coupled next to the cyclic prefix removing circuit 120, the baseband signal without a cyclic prefix is transformed from the time domain into the frequency domain. For illustrative purposes, the received data for the K^{th} subcarrier of the S^{th} symbol after the FFT operation can be expressed as Y_{s,k}. The FFT output Y_{s,k} for the K^{th} subcarrier of the S^{th} symbol is then transmitted to the channel estimation circuit 170, the channel state information (CSI) estimation circuit 180 and the equalizer 140 (in this exemplary embodiment, the equalizer 140 is implemented using a frequency domain equalizer). The channel estimation circuit 170 estimates the channel response corresponding to the FFT output Y_{s,k} for the K^{th} subcarrier of the S^{th} symbol, wherein the estimated channel response in the following descriptions can be expressed as Ĥ_{s,k}. The equalizer 140 is therefore capable of removing the channel effect in the FFT output Y_{s,k} according to the estimated channel response Ĥ_{s,k} to generate the equalized data

$$\frac{{Y}_{s , k}}{{\hat{H}}_{s , k}} .$$

The hard decision circuit 150 is coupled next to the equalizer 140 and executes a hard decision operation according to the equalized data

$$\frac{{Y}_{s , k}}{{\hat{H}}_{s , k}}$$

to generate the output data

$$DEC ( \frac{{Y}_{s , k}}{{\hat{H}}_{s , k}} ) .$$

The channel state information (CSI) estimation circuit 180, coupled to the FFT circuit 130, the channel estimation circuit 170 and the hard decision circuit 150, is used to estimate the wanted noise power according to the FFT output Y_{s,k} the estimated channel response Ĥ_{s,k} generated from the channel estimation circuit 170 and the output data

$$DEC ( \frac{{Y}_{s , k}}{{\hat{H}}_{s , k}} )$$

generated from the hard decision circuit 150 to further estimates the corresponding channel state information (CSI). The channel state information (CSI) derived by the channel state information (CSI) estimation circuit 180 is used in the following processes performed in the demapper 160. The demapper 160, coupled to the equalizer140 and the channel state information (CSI) estimation circuit180, demaps the equalized data

$$\frac{{Y}_{s , k}}{{\hat{H}}_{s , k}}$$

according to the estimated channel state information (CSI). The decoder 190 decodes the demapped data from the demapper 160 to output the decoded data. Since the operations and the structure of an OFDM system is well known to people skilled in this art, and the characteristics of the present invention focuses on the channel state information (CSI) estimation circuit 180 and method, further description of other circuit blocks hence is omitted here for brevity. The detailed descriptions of the channel state information (CSI) estimation circuit 180 and the channel state information (CSI) estimation method are disclosed in the following.

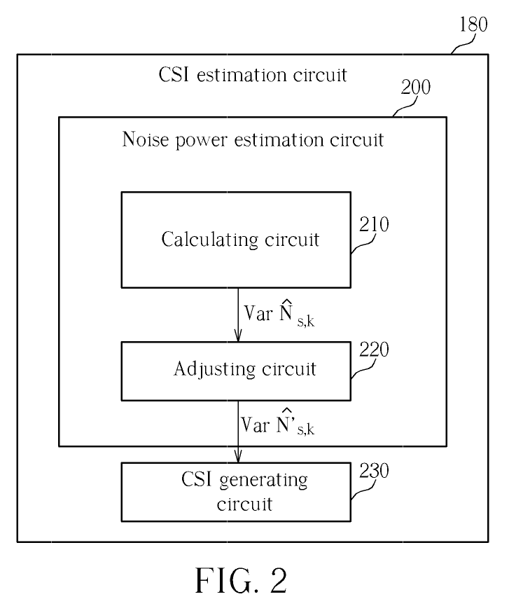

Please refer to FIG. 2 in conjunction with FIG. 1. FIG. 2 is a block diagram illustrating an exemplary embodiment of the channel state information (CSI) estimation circuit 180 shown in FIG. 1. In this exemplary embodiment, the channel state information (CSI) estimation circuit 180 includes a noise power estimation circuit 200, and a channel state information (CSI) generating circuit 230. The noise power estimation circuit 200 further includes a calculating circuit 210 and an adjusting circuit 220. The noise power estimation circuit 200 uses the calculating circuit 210 to get an evaluated noise power. For instance, the calculating circuit 210 may calculate the noise for the K^{th} subcarrier of the S^{th} symbol via the aforementioned equation (1) to get an evaluated noise \hat{N}_{s,k}. In a case where the calculating circuit 210 is configured to employ the IIR averaging method for deriving the noise variance, an evaluated noise variance corresponding to the evaluated noise \hat{N}_{s,k} is thereby derived. The evaluated noise variance for the K^{th} subcarrier of the S^{th} symbol can be viewed as the demanded noise power and is denoted as Var \hat{N}_{s,k}. In conventional designs, the evaluated noise power Var \hat{N}_{s,k} is directly transmitted to the channel state information (CSI) generating circuit 230 to output a corresponding channel state information (CSI). That is, conventionally no adjusting/tuning scheme related to the evaluated noise power Var \hat{N}_{s,k} is used. However, in the present invention, the adjusting circuit 220 compares the evaluated noise power Var \hat{N}_{s,k} with a target threshold to adjust the value of the evaluated noise power to generate a final noise power Var \hat{N}_{s,k}, wherein the target threshold can be a predetermined constant or can be dynamically derived according to mathematical operations. The channel state information (CSI) generating circuit 230 generates a corresponding channel state information (CSI) based on the final noise power Var \hat{N}′_{s,k}.

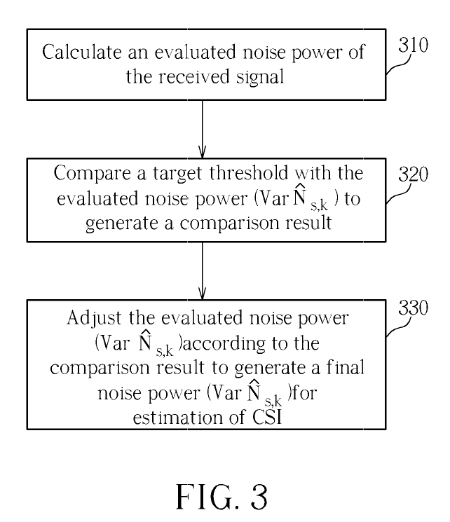

Please refer to FIG. 3 in conjunction with FIG. 1 and FIG. 2. FIG. 3 is a flowchart illustrating a simplified noise power estimation method according to a first exemplary embodiment of the present invention. In the first exemplary embodiment, the target threshold adopted in the comparison operation is a fixed (predetermined) value. The exemplary flow includes the following steps:

Step 310: Calculate an evaluated noise power of the received signal, for instance, an evaluated noise power (Var \hat{N}_{s,k}) which is equivalent to the variance of the noise for the K^{th} subcarrier of the S^{th} symbol.

Step 320: Compare a target threshold with the evaluated noise power (Var \hat{N}_{s,k}) to generate a comparison result. In this exemplary embodiment, the target threshold is a predetermined constant according to design requirements.

Step 330: Adjust the evaluated noise power (Var \hat{N}_{s,k}) according to the comparison result to obtain a final noise power (Var \hat{N}′_{s,k}) for estimation of channel state information (CSI). In this exemplary embodiment, when the comparison result indicates that the evaluated noise power (Var \hat{N}_{s,k}) is larger than then the target threshold which is a constant, the evaluated noise power is selected as the final noise power (Var \hat{N}′_{s,k}); however, when the target threshold is larger than the evaluated noise power (Var \hat{N}_{s,k}), the target threshold is selected as the final noise power (Var \hat{N}′_{s,k}).

The final noise power (Var \hat{N}′_{s,k}) will then be used as an important index in the channel state information (CSI) generating circuit 230 to estimate the corresponding channel state information (CSI). Specifically, the channel state information (CSI) is a coefficient indicating the reliability of the currently processed signal.

In the conventional case, once the noise powers corresponding to some subcarriers (nullified subcarriers) are underestimated and fail to represent the real situation, the performance of the following circuits will be excessively degraded. For instance, the decoder 190 which can be a forward error correlation (FEC) decoder may fail to decode the received signal precisely when the noise power is erroneously estimated. The noise power estimation circuit 200, however, dynamically adjusts the evaluated noise power (Var \hat{N}_{s,k}) according to the comparison result of the evaluated noise power (Var \hat{N}_{s,k}) and the target threshold. Therefore, the problem caused by an underestimated noise power can be effectively solved.

However, in a second exemplary embodiment of the present invention, the target threshold which the adjusting circuit 220 uses to judge the condition of the evaluated noise power (Var \hat{N}_{s,k}) is a variable value instead of a fixed (constant) value. In this embodiment, the target threshold value used to be compared with the evaluated noise power (Var \hat{N}_{s,k}) is derived via several mathematical operations. The calculating circuit 210 further calculates an average value of a plurality of evaluated noise powers corresponding to a specified symbol. Then the calculating circuit 210 further obtains a reference noise power based on the average value.

For instance, in an example of the present invention, to calculate the reference noise power associated with the target threshold for a K^{th} subcarrier of S^{th} symbol, the calculating circuit 210 sums up the evaluated noise powers for the plurality of subcarriers of the (S−1)^{th} symbol to generate a summation result, and calculate an average evaluated noise power of the (S−1)^{th} symbol. After getting the average evaluated noise power of the (S−1)^{th} symbol, the calculating circuit 210 further sets a reference noise power by multiplying the average evaluated noise power by a predetermined coefficient, wherein the value of the predetermined coefficient varies according to design requirements. The aforementioned mathematical operations can be expressed using several equations as illustrated below.

$${\overline{Var N}}_{s - 1 , k} = \frac{1}{FFT\_Size} {\sum }_{k = 0}^{L - 1} {VarN}_{s - 1 , k} \qquad ( 4 )$$

V̅a̅r̅N̅_{s-1,k} represents the average evaluated noise power of the (S−1)^{th} symbol. When the OFDM receiver 100 is operated in an 8K mode, the corresponding FFT_Size would be 8192, and when the OFDM receiver 100 is operated in a 2K mode, the corresponding FFT_Size would be 2048.

A simple exemplary embodiment for deriving the reference noise power is expressed as follows:

LB_REL_VarNₛ=β V̅a̅r̅N̅ₛ₋₁ (5)

where β in the exemplary embodiment can be a positive constant set according to the design requirement, V̅a̅r̅N̅ₛ₋₁ represents the average evaluated noise power of the (S−1)^{th} symbol, and the reference noise power is denoted as LB_REL_VarNₛ. Furthermore, in some preferred cases, the predetermined coefficient β can be a value greater than 0 and not greater than 1, i.e., 0<β≦1.

In this exemplary embodiment, the noise power estimation circuit 200 further determines the target threshold according to another coefficient. For example, the adjusting circuit 220, as shown in FIG. 2, further compares the reference noise power LB_REL_VarNₛ with a predetermined constant to determine the target threshold. The operations are expressed as follows:

LB_VarNₛ=min {LB_ABS_VarN,LB_REL_VarNₛ} (6)

VarN′_{s,k}=max {LB_VarNₛ,VarN_{s,k}} (7)

where the target threshold is denoted as LB_VarNs, the predetermined constant is denoted as LB_ABS_VarN, and the final noise power is expressed as Var \hat{N}′_{s,k}. In detail, in the equation (6) and (7), the adjusting circuit 220 compares the reference noise power LB_REL_VarNₛ with the predetermined constant LB_ABS_VarN to select a minimum of the reference noise power LB_REL_VarNₛ and the predetermined constant LB_ABS_VarN to derive the target threshold LB_VarNₛ.

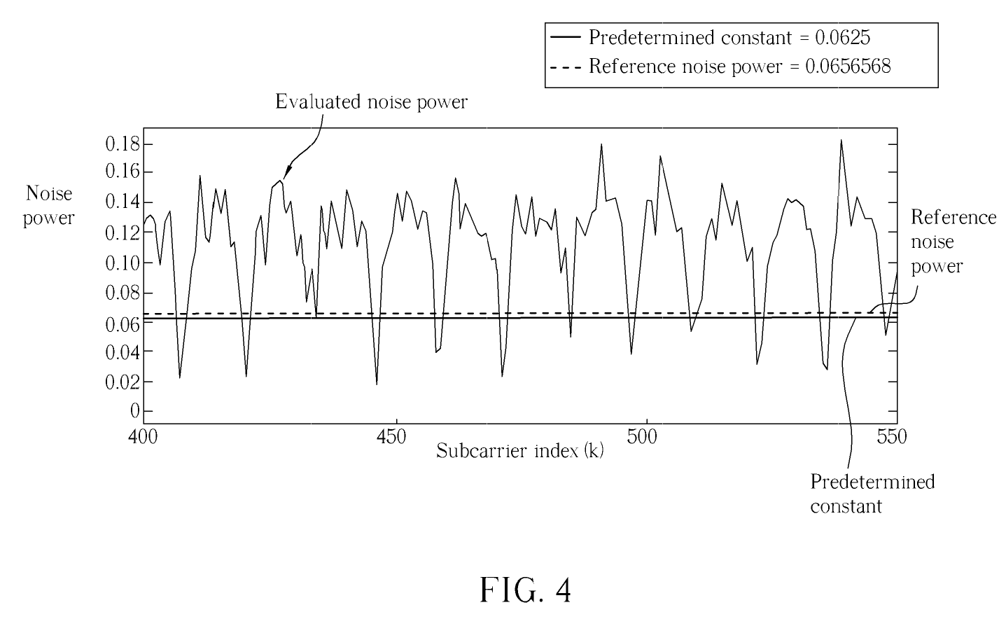

The equation (7) illustrates the step of selectively adjusting the evaluated noise power VarN_{s,k} according to the comparing operation. In other words, since the evaluated noise power VarN_{s,k} might be underestimated, the adjusting circuit 220 sets the target threshold LB_VarNs to serve as a lower bound of the evaluated noise power. When the comparison result of the adjusting circuit 220 indicates that the target threshold LB_VarNs is greater than the evaluated noise power, the adjusting circuit 220 can update the evaluated noise power by the target threshold LB_VarNs (i.e., selects the target threshold LB_VarNₛ as the final noise power Var \hat{N}′_{s,k} or the K^{th} subcarrier of the S^{th} symbol). When the comparison result indicates the target threshold LB_VarNₛ is not greater than the evaluated noise power VarN_{s,k}, the adjusting circuit 220 keeps the evaluated noise power VarN_{s,k} as the final noise power Var \hat{N}′_{s,k} for the K^{th} subcarrier of the S^{th} symbol). For clarity, an exemplary relation between the reference noise power LB_REL_VarNₛ, the predetermined constant LB_ABS_VarN and the evaluated noise power according to the second exemplary embodiment mentioned above is illustrated in FIG. 4.

In conclusion, the aforementioned embodiments of the present invention provide a noise power estimation method and circuit capable of getting better estimated channel state information (CSI) of the received signal in an OFDM receiver by using a lower bound scheme and a comparing operation. By using the noise power estimation circuit for estimation of channel state information (CSI), the receiver in the present invention hence has an improved signal processing performance. Please note that the mathematical algorithm applied for calculating the noise power is not limited to be an IIR averaging method. In a practical implementation, the mathematical algorithm can be different according to different design requirements. Similarly, the operations for deriving the target threshold are not restricted to the above-mentioned equations. All alternative designs obeying the spirit of the present invention fall within the scope of the present invention.

Compared with a conventional noise power estimation circuit and method, the disclosed noise power estimation circuit and method provide precise channel state information (CSI) even when a received signal corresponds to nullified subcarriers.

It is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

Those skilled in the art will readily observe that numerous modifications and alterations of the device and method may be made while retaining the teachings of the invention.

What is claimed is:

1. A noise power estimation method for estimation of channel state information in OFDM systems, comprising:
calculating an evaluated noise power for a specific subcarrier of a current symbol;
comparing a target threshold with the evaluated noise power for the specific subcarrier of the current symbol to generate a comparison result; and
determining a final noise power for estimation of channel state information by adjusting the evaluated noise power for the specific subcarrier of the current symbol according to the comparison result.

2. The noise power estimation method of claim 1, wherein the target threshold is a predetermined constant.

3. The noise power estimation method of claim 1, further comprising:
calculating a reference noise power of the current symbol according to a plurality of evaluated noise powers for a plurality of subcarriers of a preceding symbol which precedes the current symbol; and
determining the target threshold according to comparison of the reference noise power and a predetermined constant.

4. The noise power estimation method of claim 3, wherein calculating the reference noise power is determined based on average of the plurality of evaluated noise powers for the plurality of subcarriers of the preceding symbol.

5. The noise power estimation method of claim 3, wherein the target threshold is determined as the minimum of the reference noise power and the predetermined constant.

6. The noise power estimation method of claim 1, wherein the final noise power for estimation of channel state information is determined as the maximum of the evaluated noise power and the target threshold.

7. The noise power estimation method of claim 1, wherein the evaluated noise power for the specific subcarrier of the current symbol is obtained according to an infinite impulse response (IIR) averaging method.

8. A noise power estimation circuit for estimation of channel state information in
an OFDM receiver, comprising:
a calculating circuit, for calculating an evaluated noise power for a specific subcarrier of a current symbol; and
an adjusting circuit, for comparing a target threshold with the evaluated noise power for the specific subcarrier of the current symbol to generate a comparison result, and obtaining a final noise power for estimation of channel state information by adjusting the evaluated noise power for the specific subcarrier of the current symbol according to the comparison result.

9. The noise power estimation circuit of claim 8, wherein the target threshold is a predetermined constant.

10. The noise power estimation circuit of claim 8, wherein the target threshold is determined by calculating a reference noise power of the current symbol according to a plurality of evaluated noise powers for a plurality of subcarriers of a preceding symbol which precedes the current symbol, and comparing the reference noise power and a predetermined constant.

11. The noise power estimation circuit of claim 10, wherein the reference noise power is calculated according to the average of the plurality of evaluated noise powers for the plurality of subcarriers of the preceding symbol.

12. The noise power estimation circuit of claim 10, wherein the target threshold is determined as the minimum of the reference noise power and the predetermined constant.

13. The noise power estimation circuit of claim 8, wherein the final noise power for estimation of channel state information is determined as the maximum of the evaluated noise power and the target threshold.

14. The noise power estimation circuit of claim 8, wherein the evaluated noise power for the specific subcarrier of the current symbol is determined by an infinite impulse response (IIR) averaging method.
